(19) United States
(12) Patent Application Publication
(10) Pub. No.: US 2012/0113071 A1
(43) Pub. Date: May 10, 2012

(54) INPUT DEVICE, COORDINATES DETECTION METHOD, AND PROGRAM

(75) Inventors: Hiroto Kawaguchi, Miyagi (JP); Ryota Kitamura, Miyagi (JP)

(73) Assignee: Sony Corporation, Tokyo (JP)

(21) Appl. No.: 13/286,487

(22) Filed: Nov. 1, 2011

(30) Foreign Application Priority Data
Nov. 8, 2010 (JP) 2010-249975

(51) Int. Cl. G09G 5/00

(52) U.S. Cl. 345/204

(57) ABSTRACT

An input device includes an input operation surface which includes a display region, a display element which displays an operation screen, where an operation region is included in at least a portion thereof, in the display region, a sensor section which has a plurality of electrodes which are individually driven using scanning of electric signals and electrostatically detects an input position in the input operation surface, and a driving section which has a first driving mode where all out of the plurality of electrodes are driven and a second driving mode where a portion of the electrodes out of the plurality of electrodes are driven.

### BACKGROUND

The present disclosure relates to an input device, a coordinates detection method, and a program which detect a contacting or proximity position of a finger using a change in capacitance.

In recent years, electronic apparatuses, which detect the position of a finger based on changes in capacitance and control display on a screen or operations of the apparatus, are widely used. As this type of capacitance sensor, a method is typical where the change in capacitance in each of a plurality of electrodes arranged in a flat surface is detected and an input position is determined based on the contacting or proximity of a finger in the flat surface.

For example, in Japanese Unexamined Patent Application Publication No. 2008-117371, an information display device is disclosure where a display unit such as a LCD and a sensor unit, which has a plurality of detection electrodes which are attached to a surface of the display unit and are arranged in a two dimensional planar shape, are provided. In the information display device of this type, detection of an input position by scanning of the detection electrodes and controlling of the display state of information is typical.

### SUMMARY

However, since the output of the electrodes is normally referenced not only in an input position but also in a non-input position, it is easy for influence to be received due to disturbances in normal scanning of all of the electrodes and it is difficult to improve detection accuracy such as detection of errors in the input position.

It is desirable that an input device, a coordinates detection method, and a program are proposed which are able to increase detection accuracy of the input position.

An input device according to an embodiment of the disclosure is provided with an input operation surface, a display element, a sensor section, and a driving section.

The input operation surface includes a display region.

The display element displays an operation screen, where an operation region is included in at least a portion thereof, in the display region.

The sensor section has a plurality of electrodes which are individually driven by scanning of electric signals and electrostatically detects an input position in the input operation surface.

The driving section has a first driving mode where all out of the plurality of electrodes are driven and a second driving mode where a portion of the electrodes out of the plurality of electrodes are driven. The driving section calculates the coordinates of the input position by executing either the first driving mode or the second driving mode in accordance with the operation region.

The input device selects the electrodes to be driven in accordance with the operation region in the operation screen. For example, in a case where the entire operation screen is the operation region, the first driving mode is executed. On the other hand, in a case where only a partial region of the operation screen is the operation region, by executing the second driving mode, only the electrodes which belong to the operation region are selectively driven. By selecting the electrodes which are to be driven in accordance with the size of the operation region in this manner, the influence due to disturbances is reduced and detection of the input position with high accuracy is possible. In addition, since it is sufficient if only a portion of the electrodes is driven in accordance with the operation screen, it is possible to reduce the power consumed in comparison with the case where all of the electrodes are normally driven. Furthermore, since it is easy to speed up the scanning period, it is possible to achieve a further improvement in the detection accuracy of the input position.

The first driving mode may have a first standard driving mode and a first partitioned driving mode.

The first standard driving mode calculates the coordinates of the input position by sequentially driving all of the plurality of electrodes.

The first partitioned driving mode partitions the plurality of electrodes in the operation region into a plurality of regions, and by driving the electrodes in each of the partitioned regions, calculates the respective coordinates of the input position in each of the regions.

In this case, when the first driving mode is selected, the driving section further selects either the first standard driving mode or the first partitioned driving mode.

In the partitioned driving mode, it is possible to partition the input operation surface into a plurality of regions and calculate the input position coordinates independently in relation to each of the regions. Due to this, it is possible to detect an input position at two or more points at the same time in the input operation surface, and in addition, there is an improvement in the detection accuracy for detecting the input position using only a limited number of electrodes in each of the regions.

In this same manner, the second driving mode may have a second standard driving mode and a second partitioned driving mode.

The second standard driving mode calculates the coordinates of the input position by sequentially driving a portion of the electrodes out of the plurality of electrodes.

The second partitioned driving mode partitions the portion of the electrodes in the operation region into a plurality of regions, and by driving the electrodes in each of the partitioned regions, calculates the respective coordinates of the input position in each of the regions.

In this case, when the second driving mode is selected, the driving section further selects either the second standard driving mode or the second partitioned driving mode.

The input device may be further provided with a display control device.

The display control section outputs a screen control signal which controls display of the operation screen to the display element and outputs a region signal in relation to the operation region in the operation screen to the driving section.

In this case, the driving section selects either of the first driving mode or the second driving mode based on the region signal.

The sensor section may further have a support body which is arranged between input operation surface and the display element and supports the plurality of electrodes together. The plurality of electrodes is arranged on the support body along a first direction and a second direction which is orthogonal to the first direction.

Due to this, it is possible to realize a thinner sensor section.

In the case described above, for example, the sensor section may have a first electrode, a second electrode, and a third electrode.

The first electrode has a first region where the height dimension which is parallel to the second direction becomes gradually larger in relation to a width direction which is parallel to the first direction and a second region where the height dimension becomes gradually smaller in relation to the width direction.

The second electrode is formed so as to face the first region in the second direction and so that the height dimension which is parallel to the second direction becomes gradually smaller in relation to the first direction.

The third electrode is formed so as to face the second region in the second direction, to face the second electrode in the first direction, and so that the height dimension which is parallel to the second direction becomes gradually larger in relation to the first direction.

A plurality of the groupings of the first electrode, the second electrode, and the third electrode are arranged along the second direction on the support body.

Due to this, it is possible to increase the detection accuracy of the input position along the first direction. In addition, since the first to the third electrodes are arranged along the second direction on the support body, it is possible to also detect changes in the input position along the second direction with high accuracy based on the rate of change in capacitance of the electrodes.

A coordinates detection method according to an embodiment of the disclosure includes displaying an operation screen where an operation region is included in at least a portion thereof in a display region of an input operation surface.

A plurality of electrodes, which are individually driven using an operation of electric signals, are selected from among a plurality of electrodes, which electrostatically detect an input position in the input operation surface, in accordance with the operation region.

The coordinates of the input position are calculated by driving the selected plurality of electrodes.

The coordinates detection method makes it possible to reduce the influence due to disturbances and to detect the input position with high accuracy by selecting the electrodes which are to be driven in accordance with the size of the operation region. Due to this, it is possible to reduce the power consumed in comparison with the case where all of the electrodes are normally driven. Furthermore, since it is easy to speed up the scanning period, it is possible to achieve a further improvement in the detection accuracy of the input position.

A program according to an embodiment of the disclosure causes the input device to execute the coordinates detection method. The program may be recorded in a recording medium.

According to the embodiments of the disclosure, it is possible to increase the detection accuracy of the input position.

### BRIEF DESCRIPTION OF THE DRAWINGS

FIG. 1 is a schematic perspective diagram illustrating a configuration of an input device according to an embodiment of the present disclosure;

FIG. 2 is a planar diagram describing an electrode configuration of a sensor section which configures the input device;

FIG. 3 is an enlarged diagram illustrating one electrode grouping of the sensor section;

FIGS. 4A and 4B are diagrams describing a detection principle of the sensor section;

FIG. 5 is a diagram describing a detection principle of the sensor section;

FIGS. 6A to 6C are diagrams describing a detection principle of the sensor section;

FIG. 7 is a control flow describing one operation example of the input device;

FIG. 8 is a planar diagram illustrating one configuration example of the sensor section;

FIGS. 9A and 9B are diagrams describing a driving method of the sensor section;

FIGS. 10A to 10E are diagrams describing a driving method of the sensor section;

FIGS. 11A and 11B are diagrams describing an operation example of the input device where FIG. 11A shows an operation screen and FIG. 11B shows a driving method of the sensor section;

FIGS. 12A and 12B are diagrams describing an operation example of the input device where FIG. 12A shows an operation screen and FIG. 12B shows a driving method of the sensor section;

FIGS. 13A and 13B are diagrams describing an operation example of the input device where FIG. 13A shows an operation screen and FIG. 13B shows a driving method of the sensor section;

FIGS. 14A and 14B are diagrams describing an operation example of the input device where FIG. 14A shows an operation screen and FIG. 14B shows a driving method of the sensor section;

FIGS. 15A and 15B are diagrams describing an operation example of the input device where FIG. 15A shows an operation screen and FIG. 15B shows a driving method of the sensor section;

FIG. 16 is a diagram describing an operation example of the input device;

FIG. 17 is a diagram describing an operation example of the input device;

FIG. 18 is a diagram describing an operation example of the input device;

FIG. 19 is a diagram describing an operation example of the input device;

FIG. 20 is a diagram describing an operation example of the input device;

FIG. 21 is a diagram describing an operation example of the input device;

FIG. 22 is a diagram describing an operation example of the input device;

FIG. 23 is a diagram describing an operation example of the input device;

FIG. 24 is a diagram describing an operation example of the input device;

FIG. 25 is a diagram describing an operation example of the input device;

FIG. 26 is a diagram describing an operation example of the input device;

FIGS. 27A to 27D are diagrams describing an operation example of the input device;

FIG. 28 is a planar diagram describing a modified example of an electrode configuration of the sensor section;

FIG. 29 is a planar diagram describing a modified example of an electrode configuration of the sensor section; and

FIG. 30 is a planar diagram describing a modified example of an electrode configuration of the sensor section.

### DETAILED DESCRIPTION OF EMBODIMENTS

Below, the embodiment of the disclosure will be described while referencing the diagrams.

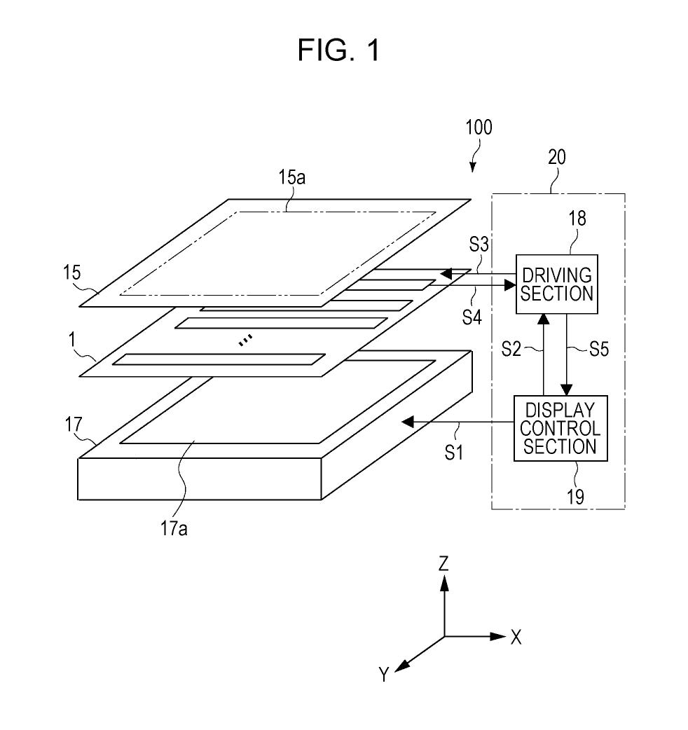

FIG. 1 is an exploded perspective diagram schematically illustrating an input device according to an embodiment of the disclosure. The input device of the embodiment configures a user interface which is provided on a screen display section of various types of electronic apparatus such as a mobile information terminal, a digital camera, a video camera, a personal computer, or a car navigation system.

[Schematic Configuration of Input Device]

An input device 100 of the embodiment has a sensor section 1, an input operation surface 15, a display element 17, a driving section 18, and a display control section 19. Here, the diagrammatic display of the housing which contains the sensor 1, the display element 17, and the like are omitted.

The input operation surface 15 is formed by a flat plate or a sheet which is formed on a surface of a portion of a housing. The input operation surface 15 has optical transparency and has a display region 15a, which corresponds to a display surface 17a of the display element 17, in the input operation surface 15. The input operation surface 15 is formed by a transparent plastic material, glass material, or the like.

Here, a Z axial direction in FIG. 1 indicates an axial direction which is perpendicular to the display region 15a, and X and Y axial directions indicate two axial directions which are parallel to the display region 15a and are perpendicular each other. The X axial direction and the Y axial direction typically correspond to the horizontal direction and the vertical direction of each of the screens, but the X axial direction and the Y axial direction may become the horizontal direction and the vertical direction of each of the screens in accordance with the state of the displaying screen.

The display element 17 is formed by a liquid crystal display (LCD), an organic EL display, or the like, and has the display surface 17a which displays an operation screen in the display region 15a of the input operation surface 15. In the operation screen, other than reproduced images, captured images, and the like, various types of screens are included which display operation images such as a key, an icon, or the like for input operations by a user. Here, a region where the operation images are displayed is referred to as an operation region. The operation region may be the entire region of the display region 15a or may be a partial region of the display region 15a.

The display control section 19 outputs a screen control signal S1 which controls display of the operation screen to the display element 17. In addition, the display control section 19 outputs a region signal S2 which includes information in relation to the operation region in the operation screen to the driving section 18.

The sensor section 1 is arranged between the input operation surface 15 and the display surface 17a of the display element 17. The sensor section 1 is configured by a capacitance touch sensor which has optical transparency, and as will be described later, has a plurality of electrodes which are individually driven using scanning of electric signals.

The sensor section 1 electrostatically detects a finger (finger tip) of a user which is in the proximity of or comes into contact with the input operation surface 15.

Typically, the sensor section 1 detects the contact position (referred to below as “input position”) of the finger tip in the input operation surface 15 which includes the display region 15a. A signal in relation to the detected input position is output as a sensor signal S4 which includes coordinates information of the input position in the XY plane to the driving section 18.

The driving section 18 is typically configured by a computer. The driving section 18 has a signal generating circuit which inputs a driving signal S3 to the sensor section 1 and a calculation circuit which calculates the input position based on the sensor signal S4. The signal generating circuit may include a plurality of signal generating circuit paths and the calculation circuit may include a plurality of calculation circuit paths. Due to this, it is possible to drive the sensor section 1 using a partitioned driving mode which will be described later.

In the driving signal S3, a pulse signal with a predetermined frequency is used, but other than this, another electric signal such as a high frequency signal may be used. The driving circuit scans each of the electrodes over a predetermined cycle by applying the driving signal S3 sequentially to the plurality of electrodes which are to be driven. The calculation circuit sequentially calculates the capacitance of each of the driven electrodes and determines the electrode position which show a capacitance which is above (or below) a predetermined threshold as the input position.

The driving section 18 has a first driving mode where all out of the plurality of electrodes in the sensor section 1 are driven and a second driving mode where a portion of the electrodes out of the plurality of electrodes are driven. Then, the driving section 18 calculates the XY coordinates of the input position by executing either the first driving mode or the second driving mode in accordance with the operation region.

The first driving mode corresponds to a full scan mode where all of the electrodes in the sensor section 1 are scanned and the second driving mode corresponds to a partial scan mode where only a portion of the electrode in the sensor section 1 are driven.

In the second driving mode, only the electrodes which belong to the operation region are selectively driven based on the region signal S2 which is input from the display control section 19 to the driving section 18. A plurality of the second driving modes is set in accordance with a plurality of the operation screens where the operation regions are different, and the range or number of electrodes which are driven in accordance with the state of the operation region changes. In the second driving mode, not only cases where there is a single operation region but cases where there are a plurality of operation regions are also included.

The first driving mode in the embodiment is divided into a standard driving mode (first standard driving mode) and a partitioned driving mode (first partitioned driving mode). When the first driving mode is selected, the driving section 18 further selects either the standard driving mode or the partitioned driving mode.

The first standard driving mode calculates the coordinates of the input position by sequentially driving all of the plurality of electrodes in the sensor section 1. The first partitioned driving mode partitions the plurality of electrodes in the operation region into a plurality of regions, and by driving the electrodes in each of the partitioned regions, calculates the respective coordinates of the input position in each of the regions. As will be described below, for example, in the partitioned driving mode, the operation region is partitioned into a first region and a second region and the input positions in the first and the second regions are mutually calculated independently. Due to this, a multi-touch function is able to be realized. The calculation processes of the input positions in each of the regions are each executed in parallel.

On the other hand, the second driving mode also has a standard driving mode (second standard driving mode) and a partitioned driving mode (second partitioned driving mode). When the second driving mode is selected, the driving section 18 further selects either the standard driving mode or the partitioned driving mode.

The second standard driving mode calculates the coordinates of the input position by sequentially driving a portion of the electrodes which are driven in the second driving mode out of the plurality of electrodes in the sensor section 1. The second partitioned driving mode partitions the portion of the electrodes in the operation region into a plurality of regions, and by driving the electrodes in each of the partitioned regions, calculates the respective coordinates of the input position in each of the regions. Due to this, a multi-touch function is able to be realized. The calculation processes of the input positions in each of the regions are each executed in parallel.

The driving section 18 outputs a coordinates signal S5 which includes coordinate information of the input position which is calculated based on the sensor signal S4 to the display control section 19. In the coordinate signal S5, other than the XY coordinates of the input position, information is included in relation to a movement direction, a movement speed, an amount of movement, and the like of a finger tip which are determined by a time calculation (differential or integral) of the coordinates position.

The display control section 19 is typically configured by a computer, adjusts the screen control signal S1 based on the coordinates signal S5, and executes the screen display according to the input operation of a user. For example, a change of screen or image display control due to the execution of an operation key or icon which corresponds to the input position, image rotation which corresponds to a movement direction or the amount of movement of the input position, zoom in or zoom out control, and the like are executed.

The display control section 19 includes a controller 20 which controls the overall functions of the input device 100 and the electronic apparatus which includes the input device 100. The driving section 18 may also include the controller 20. The controller 20 controls the operation of the electronic apparatus according to the coordinates information of the input position. The display control section 19 is not limited to an example of being configured as another circuit with the driving section 18, but may be configured as a circuit which is integrated with the driving circuit 18. For example, the display control section 19 and the driving section 18 are able to be configured by a single semiconductor chip (IC chip).

Here, the display control section 19 may be provided in another control device other than the input device 100. In this case, transferring of signals between the display control section 19 and the driving section 18 is able to be realized by wired communication or wireless communication.

[Configuration Example of Capacitance Sensor]

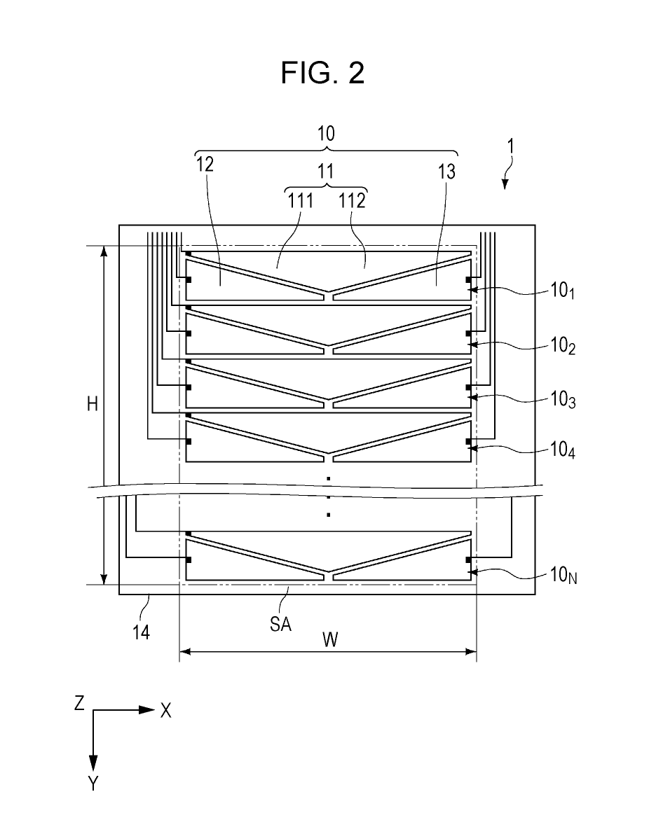

Next, a configuration example of the sensor section 1 will be described. FIG. 2 is a schematic planar diagram of the sensor section 1.

The sensor section 1 has a detection area SA with a width W and a height H. The size of the detection area SA is set to a size which is able to cover the entirety of the display region 15a. The sensor section 1 is configured as a sensor panel which detects the proximity or the contacting of a detected object (for example, a finger of a user) in the detection area SA based on a change in capacitance.

The sensor section 1 has a support body 14 which supports electrode groupings of a plurality of electrode groupings of 10₁, 10₂, 10₃, 10₄, . . . , 10_{N} as shown in FIG. 2. Each of the electrode groupings is arranged on the surface of the support body 14 in a constant pitch along the Y axial direction. In FIG. 2, each of the electrode groupings are indicated as the electrode groupings 10₁, 10₂, 10₃, 10₄, . . . , 10_{N} in order along the +Y direction (the second direction), but since each of the electrode groupings has the same configuration, each of the electrode groupings will be referred to as “electrode grouping 10” in the specifications except for cases of being describe individually.

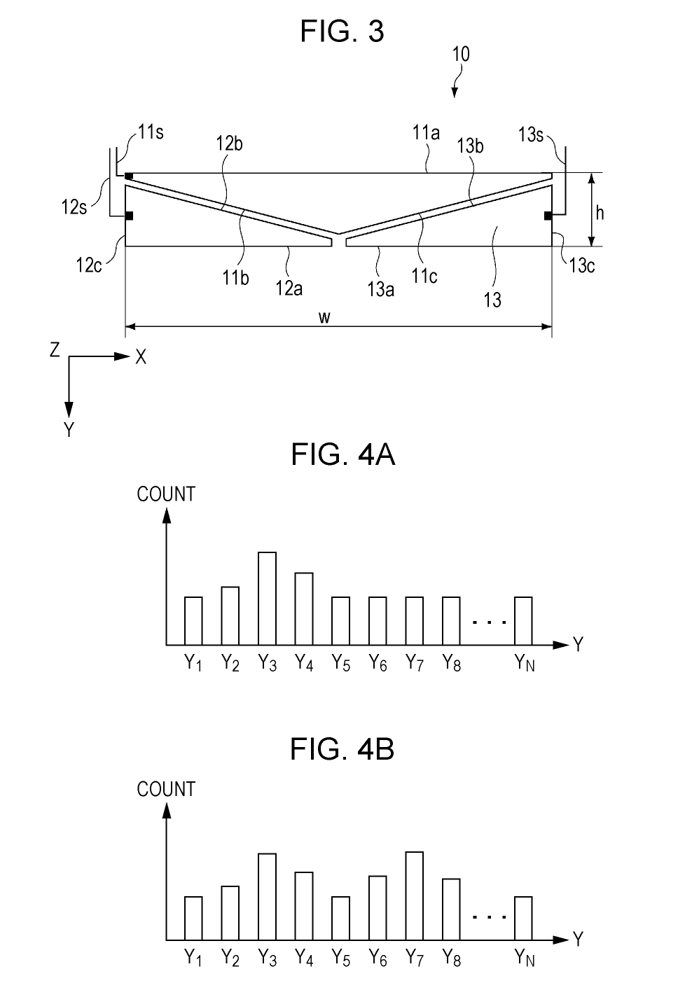

As shown in FIG. 2, the electrode grouping 10 has a configuration with a rectangular shape with a width w and a height h and is divided into a first electrode 11, a second electrode 12, and a third electrode 13. FIG. 3 is an enlarged planar diagram illustrating one grouping of the electrode grouping 10.

The first electrode 11 has a base side 11a which is parallel to the X axial direction, and the length (w) thereof is substantially the same as the width W of the detection area SA. That is, the first electrode 11 has a width dimension which covers the width dimension of the detection area SA along the X axial direction.

The first electrode 11 has a first region 111 where the height dimension which is parallel to the +Y direction (height direction) becomes gradually larger in relation to the width direction which is parallel to the +X direction and a second region 112 where the height dimension becomes gradually smaller in relation to the +X direction. In the embodiment, the first electrode 11 is formed substantially as an isosceles triangle with two sloping sides 11b and 11c where the largest value in the height dimension is formed in a middle portion in the width direction.

The second electrode 12 is formed so as to face the first region 111 in the +Y direction and so that the height dimension which is parallel to the +Y direction (height direction) becomes gradually smaller in relation to the +X direction (width direction). In the embodiment, the second electrode 12 is formed substantially by a right-angled triangle which has a base side 12a which is parallel to the base side 11a of the first electrode 11 and has a width that is substantially half of the base side 11a, a sloping side 12b which faces the sloping side 11b of the first electrode 11, and an adjacent side 12c which is adjacent to the other sides. The sloping side 11b of the first electrode 11 and the sloping side 12b of the second electrode 12 have angles of inclination which each are the same with regard to the X axis, and a gap with a constant size is provided between the two sloping sides 11b and 12b. The size of the gap is not particularly limited and it is sufficient if it is a size so that electrical insulation between the first region 111 and the second electrode 12 is able to be secured.

The third electrode 13 is formed so as to face the second region 112 in the Y axial direction and so that the height dimension which is parallel to the +Y direction (height direction) becomes gradually larger in relation to the +X direction (width direction). In the embodiment, the third electrode 13 is formed substantially by a right-angled triangle which has a base side 13a which is parallel to the base side 11a of the first electrode 11 and has a width that is substantially half of the base side 11a, a sloping side 13b which faces the sloping side 11c of the first electrode 11, and an adjacent side 13c which is adjacent to the other sides. The sloping side 11c of the first electrode 11 and the sloping side 13b of the third electrode 13 have angles of inclination which each are the same with regard to the X axis, and a gap with a constant size is provided between the sloping sides 11c and 13b. The size of the gap is not particularly limited and it is sufficient if it is a size so that electrical insulation between the second region 112 and the third electrode 13 is able to be secured.

The second electrode 12 and the third electrode 13 face each other in the X axial direction via a gap and have a symmetrical shape in relation to a straight line which is parallel to the Y axial direction which passes through the middle portion of the first electrode 11.

The support body 14 is arranged to face the display surface 17a of the display element 17. The support body 14 supports the electrode groupings 10 which are configured as described above and maintains a state where each of the electrode groupings 10 are arranged in a predetermined pitch in the Y axial direction. The support body 14 is formed by a flexible plastic film with electrical insulation properties such as PET (polyethylene terephthalate), PEN (polyethylene naphthalate), PI (polyimide), PC (polycarbonate), and the like. Here, other than this, a rigid material such as glass, ceramics, or the like may be used.

The electrode groupings 10 (the first to third electrodes 11 to 13) and the support body 14 are each formed by a material which has translucency. For example, the electrode groupings 10 are formed by a transparent conductive oxide such as ITO (indium tin oxide), SnO, or ZnO, and the support body 14 is formed from a transparent resin film such as PET, or PEN. Due to this, the display image of the display surface 17a is able to be visually recognized from the outside via the sensor section 1.

A method of forming the electrode groupings 10 is not particularly limited. For example, a conductive film which forms the electrode groupings 10 is formed on the support body 14 using, for example, a thin film formation method such as an evaporation method, a sputtering method, or a CVD method. In this case, after the conductive film is formed on a substrate, the conductive film may be patterned into a predetermined format, or after the conductive film is formed on the surface of the substrate where a resist mask is formed, surplus conductive film may be removed (lifted off) from the substrate along with the resist mask. Other than this, an electrode pattern may be formed on a substrate using a printing method such as a plating method or a screen printing method.

The electrode groupings 10 also have a signal wire (wiring) for connecting the first to third electrode 11 to 13 to the driving section 18. In the embodiment, as shown in FIG. 3, a signal wire 11s is connected to an edge portion in the width direction of the first electrode 11 and signal wires 12s and 13s are respectively connected to one side 12c and 13c of the second electrode 12 and the third electrode 13 which face an outer side of the detection area SA.

The signal wires 11s to 13s are draw out at a region on an outer side of the detection area SA on the support body 14 and are connected to the driving section 18 via external connection terminals of connectors or the like (not shown). In addition, the signal wires 11s to 13s are each formed independently for each row of the electrode groupings 10 and are together connected to the driving section 18.

The signal wires 11s to 13s may be formed by the constituent material of the electrode groupings 10. In this case, it is possible for the signal wires 11s to 13s to be formed at the same time as the forming of the electrode groupings 10. On the other hand, the signal wires 11s to 13s may be formed by a non-translucent conductive material, for example, a metallic wiring such as Al (aluminum), Ag (silver), or Cu (copper). In this case, since it is possible to configure the wiring layer using a material with low specific resistance, it is possible to detect changes in the capacitance of the electrode groupings 10 with high sensitivity. Furthermore, in this case, since the signal wires 11s to 13s are positioned at an outer side of the detection area SA, image visibility is not hindered by the signal wires 11s to 13s in a case where the outer side of the detection area SA is outside of the effective pixel region of the display surface 17a.

The width w of the electrode grouping 10 is set in combination with the width W of the detection area SA. The width w of the electrode groupings 10 may be the same as the width W of the detection area SA or may be larger or smaller than the width W. The point is that, using one of the electrode grouping 10, a size is formed which is able to cover the entire width of the detection area SA, and there is a configuration so that two or more of the electrode groupings 10 are not parallel in relation to the width direction of the detection area SA.

On the other hand, the height h of the electrode grouping 10 is arbitrary set in accordance with the height of the detection area SA, the size of the detection target, the detection resolution in the Y axial direction, and the like. In the embodiment, in consideration of the detection object being set as a finger of a user and the size of a finger tip which touches the operation surface, the height h of the electrode grouping 10 is set at, for example, 5 mm to 10 mm. In the same manner, the number of rows of the electrode groupings 10 along the Y axial direction is not particularly limited and is arbitrarily set in accordance with the height of the detection area SA, the size of the detection target, the detection resolution in the Y axial direction, and the like.

In addition, as shown in FIG. 3, the height dimension of the first electrode 11 and the total of the height dimension of the second electrode 12 and the third electrode 13 are constant with regard to the +X direction. Due to this, since it is possible for the height dimension of the entire electrode grouping to be constant, it is possible to suppress generation of variation in the detection sensitivity according to the position of the detection target in relation to the X axial direction.

In the driving section 18 in the embodiment, the capacitance of each of the electrodes 11 to 13 and changes therein are detected using a so-called self capacitance method. The self capacitance method is also referred to as a single electrode method and one electrode is used in sensing. The electrode used in sensing has stray capacitance with regard to the ground potential and when a detection target object approaches which is grounded such as the human body (a finger), the stray capacitance of the electrodes increases. The calculation circuit calculates the proximity of the finger and the position coordinates by detecting the increase in capacitance.

[Operation Example of Capacitance Sensor]

Next, an operation example of the sensor section 1 will be described. Here, a method of detecting the input position using the first driving mode (standard driving mode) will be described. Here, the input position is determined using the driving section 18.

(Detection in Y Axial Direction)

The sensor section 1 is configured so that each row of the electrode groupings 10 is one detection group. Therefore, the operation position in the Y axial direction detects the proximity or the contacting of the detection object based on the total of the capacitance of the first to third electrodes 11 to 13 which configure the electrode grouping 10 or changes therein.

In the embodiment, at the time of detection in the Y axial direction, the total of the capacitance (count amount) of all of the electrodes 11 to 13 is detected using, for example, equation (1) below for each row of the electrode groupings 10 and the contact position of the finger in relation to the Y direction is specified from the size of the level thereof.

Count(Y_{N})=(C₁₁+C₂₂+C₁₃) (1)

In equation (1), “C₁₁” indicates a count value of the capacitance of the first electrode 11 (or the amount of change therein), “C₁₂” indicates a count value of the capacitance of the second electrode 12 (or the amount of change therein), and “C₁₃” indicates a count value of the capacitance of the third electrode 13 (or the amount of change therein). In addition, “Y_{N}” represents row numbers (10₂, 10₂, 10₃, 10₄, . . . ) of the electrode groupings 10 which are arranged in the Y axial direction, and “Count(Y_{N})” indicates a total of the count values of the capacitance of each of the electrodes 11 to 13 (or the amount of change therein) of the electrode groupings 10 in each of the rows.

FIG. 4A shows an example of a pattern of the count values output from each row of the electrode groupings 10 (10₁, 10₂, 10₃, 10₄, . . . , 10_{N}). In the capacitance detection of the self capacitance method, the amount of increase in the capacitance (stray capacitance) increases as the finger approaches. Accordingly, in this example, since the count value of the capacitance output from the electrode grouping 10₃ in the third row is the highest, it is possible to specify the proximity or the contacting of the finger in a position directly above the electrode grouping 10₃ in relation to the Y axial direction.

By setting an arbitrary threshold with regard to the count values, it is possible to determine a proximity distance of the finger with regard to the sensor section 1. That is, a first threshold (touch threshold) is set with regard to the count values and a touch operation is determined with regard to the input operation surface 15 using a finger in a case where the threshold is surpassed. In addition, a second threshold may be further set which is smaller than the first threshold. Due to this, it is possible to determine the proximity of the finger before the touch operation, and it is possible to detect an input operation of the finger where there is no contact.

In the pattern example of the count values shown in FIG. 4B, the count values of the capacitance output from the electrode grouping 10₃ in the third row and the electrode grouping 10₇ in the seventh row are the highest. In this example, an input operation example using two fingers (for example, a thumb and an index finger) is shown.

(Detection in X Axial Direction)

Next, a method of detecting the input position on the input operation surface 15 in relation to the X axial direction will be described. In the detection of the input position in relation to the X axial direction, the change in the capacitance (C₁₁) of the first electrode 11, the change in the capacitance (C₁₂) of the second electrode 12, and the change in the capacitance (C₁₃) of the third electrode 13 are referenced.

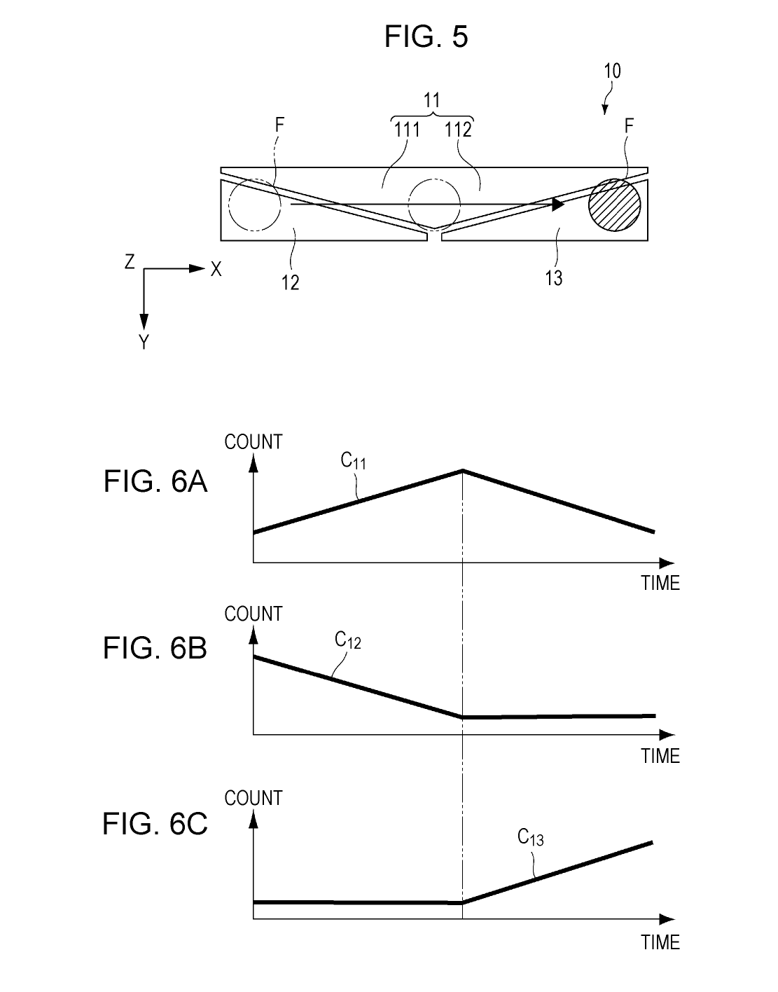

For example, when a finger F moves along the +X direction at a constant speed on an arbitrary row of the electrode groupings 10 as shown in FIG. 5, the capacitance of each of the electrode 11 to 13 changes as shown in FIGS. 6A to 6C. Here, FIG. 6A shows the change over time of the capacitance (count value) of the first electrode 11, FIG. 6B shows the change over time of the capacitance (count value) of the second electrode 12, and FIG. 6C shows the change over time of the capacitance (count value) of the third electrode 13.

A case will be considered where the finger F moves from a position shown by a one-dot chain line in FIG. 5 toward a middle portion in the width direction of the electrode grouping 10. The first electrode 11 has the first region 111 where the height dimension becomes gradually larger in relation to the +X direction, and the second electrode 12 is formed so that the height dimension becomes gradually smaller in relation to the +X direction. Accordingly, in accordance with the movement of the finger F toward the +X direction, the region where the finger F and the first electrode 11 (the first region 111) overlap becomes gradually larger but the region where the finger F and the second electrode 12 overlap becomes gradually smaller. Since the value of the capacitance is substantially proportional to the size of the region which overlaps with the finger F, the capacitance of the first electrode 11 becomes gradually larger as shown in FIG. 6A and reaches its largest value at the middle portion in the width direction of the electrode grouping 10. Opposite to this, the capacitance of the second electrode 12 becomes gradually smaller as shown in FIG. 6B and takes its smallest value at the middle portion in the width direction of the electrode grouping 10. At this time, the third electrode 13 does not overlap with the finger F and the change in capacitance is zero.

In the same manner, a case will be considered where the finger F moves from a middle portion in the width direction of the electrode grouping 10 toward a position shown by a solid line in FIG. 5. The first electrode 11 has the second region 112 where the height dimension becomes gradually smaller in relation to the +X direction, and the third electrode 13 is formed so that the height dimension becomes gradually larger in relation to the +X direction. Accordingly, in accordance with the movement of the finger F toward the +X direction, the region where the finger F and the first electrode 11 (the second region 112) overlap becomes gradually smaller but the region where the finger F and the third electrode 13 overlap becomes gradually larger. As a result, the capacitance of the first electrode 11 becomes gradually smaller as shown in FIG. 6A, and opposite to this, the capacitance of the third electrode 13 becomes gradually larger as shown in FIG. 6C. At this time, the second electrode 12 does not overlap with the finger F and the change in capacitance is zero.

According to the embodiment, since the height dimension (h) of the electrode grouping 10 is constant in relation to the width direction, there is no relationship with the operation position of the finger F and it is possible that the detection sensitivity of the finger F is constant in relation to the X axial direction. In addition, since the first electrode 11 is formed as an isosceles triangle and the second and third electrodes 12 and 13 have a symmetrical shape, it is possible to remove variation in the detection sensitivity between the first region 111 side and the second region 112 side. Due to this, the detection of the operation position of the finger F in the X axial direction with high accuracy is possible.

In addition, according to the embodiment, a boundary portion of the first electrode 11 and the second electrode 12 and a boundary portion of the first electrode 11 and the third electrode 13 are formed by the sloping side 11b, 11c, 12b, and 13b which are each straight lines. Due to this, there is a predetermined proportional relationship of the position of the detection target in relation to the width direction and the capacitor ratio between each of the electrodes and it is possible to secure stable detection sensitivity.

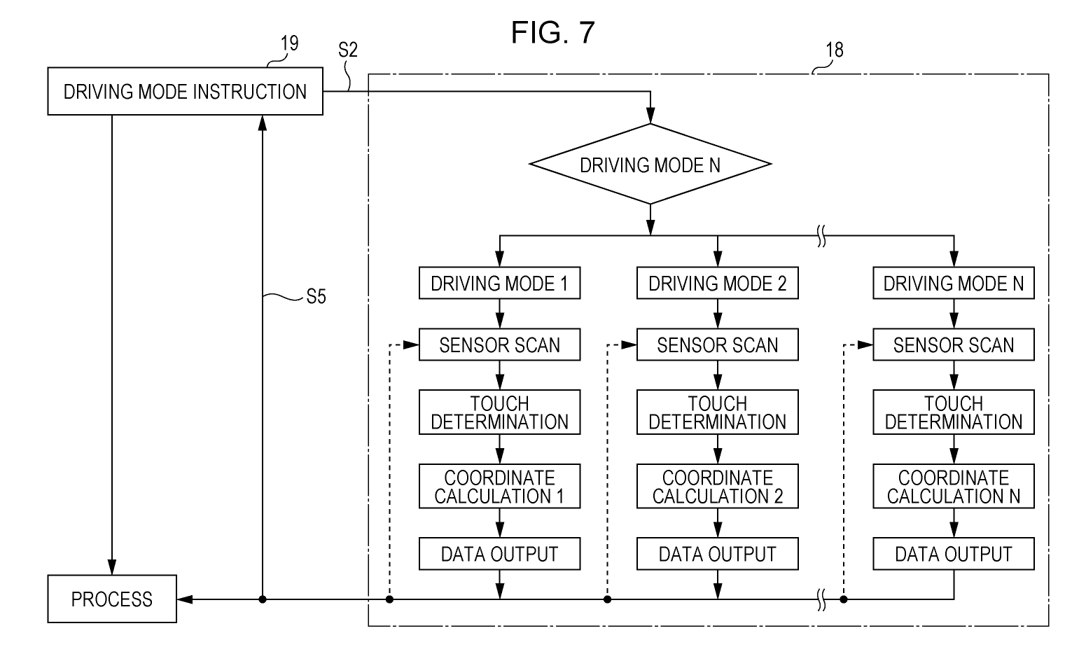

By comparing the size of the capacitance of each of the first electrode 11, the second electrode 12, and the third electrode 13 as above, the detection position of the finger F is specified in relation to the width direction.

[1] In a case where “C₁₂” exceeds the touch threshold and “C₁₃” is less than the touch threshold, the finger F is determined to be positioned on the second electrode 12 side. In this case, the X coordinate of the finger F is specified by calculating “C₁₂-C₁₁”. Opposite to this, in a case where “C₁₂” is less than the touch threshold and “C₁₃” exceeds the touch threshold, the finger F is determined to be positioned on the third electrode 13 side. In this case, the X coordinate of the finger F is specified by calculating “C₁₃-C₁₁”.

[2] In a case where both “C₁₂” and “C₁₃” are less than the touch threshold and “C₁₁+C₁₂” or “C₁₁+C₁₃” exceeds the touch threshold, the finger F is determined to be positioned in the vicinity of the middle portion of the first electrode 11. In this case, the X coordinate of the finger F is specified by calculating “C₁₂-C₁₃”.

[3] In a case where both “C₁₂” and “C₁₃” exceed the touch threshold, it is determined that input operations at two points on the second electrode 12 side and the third electrode 13 side are being performed. In this case, as shown in FIG. 7, the X coordinates of a finger F1 which is positioned on the second electrode 12 side and a finger F2 which is positioned on the third electrode 13 side are specified as below.

First, a distance Xd between the finger F1 and the finger F2 is calculated. In the calculation of the distance Xd, equation 2 below is used.

Xd=ΣC₁₂+ΣC₁₃−ΣC₁₁ (2)

Here, ΣC₁₁ has the meaning of the total of the capacitance of the first electrodes 11 in each row of the electrode groupings 10. In the same manner, ΣC₁₂ has the meaning of the total of the capacitance of the second electrodes 12 in each row of the electrode groupings 10 and ΣC₁₃ has the meaning of the total of the capacitance of the third electrodes 13 in each row of the electrode groupings 10. Using this calculation, even in a case where the fingers F1 and F2 are positioned between a plurality of adjacent electrode groupings 10, it is possible to detect the distance between each of the fingers F1 and F2 in relation to the X axial direction with high accuracy.

Next, an approximate X coordinate of the finger F1 is specified from the value of “C₁₂” and an approximate X coordinate of the finger F2 is specified from the value of “C₁₃”, and by averaging the values of the X coordinates and the values of Xd, the X coordinates of the fingers F1 and F2 are specified. As the values of “C₁₂” and “C₁₃”, it is possible to use the capacitance of the second electrode 12 and the capacitance of the third electrode 13 which are selected from the electrode groupings where the touch threshold has been surpassed out of each row of the electrode groupings 10.

As above, the XY coordinates of the input position are specified. The order of the specification of the X coordinate and the Y coordinate is not particularly limited and specification may be performed from the Y coordinate or specification may be performed from the X coordinate. In addition, according to the detection method in [3], it is possible to execute the specification of each of the X coordinate and the Y coordinate in parallel. The driving method in this case corresponds to the first partitioned driving mode.

In the detection of the input position using the second driving mode (partial scan mode), only the region or number of the driven electrodes is limited and the example described above is followed with regard to the detection principle. In addition, in regard to the first and second partitioned driving modes, by sequentially driving the corresponding electrode region for each of the partitioned operation regions, the input position in each of the partitioned operation regions is detected.

[Operation Example of Input Device]

Next, a typical operation example of the input device 100 will be described.

The input device 100 detects the position coordinates of a finger tip of a user who operates the input operation surface 15. In the detection of the coordinates of the input position, the operation screen which includes at least a portion of the operation region is displayed in the display region 15a (step 1), the driving mode of the sensor section 1 is selected in accordance with the operation region (step 2), the sensor section 1 is driven using the selected driving mode, and the coordinates of the input position are calculated (step 3). In the process such as this, the execution of the program stored in a storage section of the controller 20 is realized.

The operation screen which is displayed in the display region 15a of the input operation surface 15 is controlled using the display control section 19 (the controller 20). The display control section 19 outputs the screen control signal S1 which controls the display of the operation screen to the display element 17. In the operation screen, at least a portion of the operation region where there is an input operation by a user is included and the region signal S2 which includes information in relation to the operation region is output from the display control section 19 to the driving section 18.

The driving section 18 selects the driving mode of the sensor section 1 based on the region signal S2. For example, in a case where the operation region is set over the entire region of the operation screen, the first driving mode (full scan mode) is selected, and in a case where the operation region is set over a portion of the region of the operation screen, the second driving mode (partial scan mode), where only the electrodes which belong to the operation region are driven, is selected. After either the first driving mode or the second driving mode is selected, the driving section 18 further selected either the standard driving mode or the partitioned driving mode in accordance with the state of the operation surface.

The driving section 18 outputs the driving signal S3 which corresponds to the selected driving mode to the sensor section 1 and obtains the sensor signal S4 which corresponds to the driving signal S3 from the sensor section 1. The driving section 18 calculates whether there is an input operation in the operation region, the input position, the input operation direction, and the like based on the obtained sensor signal S4. The driving section 18 further generates the coordinates signal S5 which includes information in relation to the input position and outputs the coordinates signal S5 to the display control section 19.

The display control section 19 executes necessary screen control such as a change in the display of the image which corresponds to the input position and a change of pages in the operation screen in accordance with the coordinates signal S5. The coordinates signal S5 may be referenced in processes other than display control such as when controlling the operation of the entire apparatus.

FIG. 7 is a flow chart describing one example of the coordinates detection method of the input device. The driving section 18 receives an instruction (equivalent to the region signal S2) of the driving mode from the display control section 19 and selects the driving mode of the sensor section 1. Each of the driving modes is different in the combination of the electrodes which are driven and the coordinates calculation is performed using the output of the electrodes which are driven in the driving mode.

[Driving Example of Electrode]

FIG. 8 shows an electrode configuration of the sensor section 1. An electrode A corresponds to the first electrode 11, an electrode B corresponds to the second electrode 12, and an electrode C corresponds to the third electrode 13. In the diagram, an example is shown where six rows of the electrode groupings formed from the electrodes A, B, and C are arranged in the Y axial direction, and the X axial direction is equivalent to the vertical direction of the operation screen and the Y axial direction is equivalent to the horizontal direction of the operation screen.

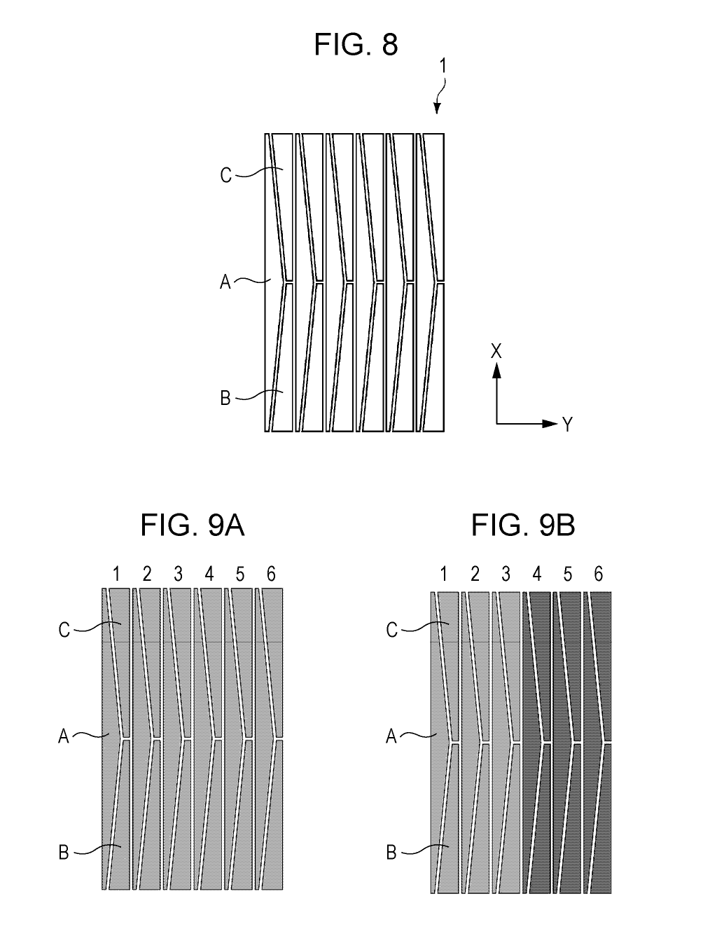

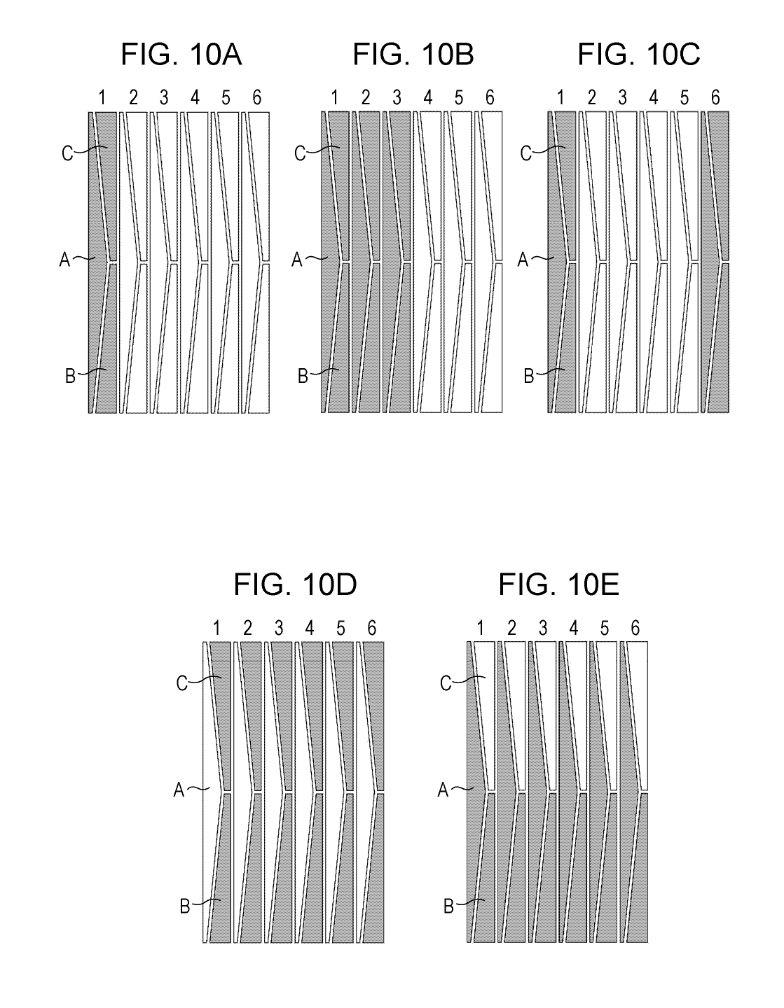

In FIG. 8, the number of electrodes (number of channels) is a total of 18 Ch. Below, a driving example of a sensor which has the electrode configuration described above will be described with reference to FIGS. 9A to 10E. Below, in order to make the description easy to understand, the driven electrodes are shown with shading.

FIGS. 9A and 9B show a driving example of electrodes using the first driving mode (full scan mode), and all of the 18 Ch electrodes are scanned. Here, FIG. 9A shows the standard driving mode and FIG. 9B shows the partitioned driving mode. In the example of FIG. 9B, the operation region is partitioned into two of the left half and the right half, and the input position is calculated independently for each of the regions. Due to this, it is possible for coordinates information for two locations to be obtained at the same time.

The number of operation regions which are partitioned in the partitioned driving mode is not limited to two as shown in the diagram, but may be three or more. In principle, the number of partitions in the operation region is possible to be as high as the number of rows of the electrode groupings, and in the example in the diagram, a maximum of six independent coordinates detections in the Y axial direction is possible.

FIGS. 10A to 10E show a driving example of electrodes using the second driving mode (partial scan mode). In the second driving mode, the number of electrodes which are scanned (scanned Ch) is limited. For example, in a case where the operation region is set on the left edge of the operation screen, only one row of the electrode groupings is driven as shown in FIG. 10A, and in this case, the scanned Ch is three. FIG. 10B shows a case where the left half of the operation screen is the operation region and the scanned Ch is nine. FIG. 10C shows a case where the left edge and the right edge of the operation screen is the operation region and the scanned Ch is six.

FIG. 10D shows a case where only the electrodes B and the electrodes C out of each row of the electrode groupings are scanned. In this case, since the scanned Ch is 12 and the operation region is substantially the entire region of the operation screen, it is appropriate to a case where a detection accuracy which is a lower accuracy than the full scan mode is sufficient.

FIG. 10E shows a case where only the electrodes A and the electrodes B out of each row of the electrode groupings are scanned. In this case, the scanned Ch is 12 and the operation region is the lower half of the screen. On the other hand, if only the electrodes A and the electrodes C are scanned, the operation region is the upper half of the screen.

The scanning method may be the standard driving mode or may be the partitioned driving mode. In the case of the partitioned driving mode, for example, in the driving example of FIG. 10C, since the electrode grouping on the left edge (the first row) and the electrode grouping on the right edge (the sixth row) are independently driven, simultaneous detection of the input coordinates is possible in each of the operation regions. In addition, in the driving example of FIG. 10D, by the rows of the electrodes B and the rows of the electrodes C being scanned independently, simultaneous detection of the input coordinates is possible in each of the regions partitioned in two into an upper and a lower region.

In the second driving mode as above, by independently setting the electrodes Ch which are to be scanned, it is possible to perform detection of the coordinates of the input position using only a specified portion of the display region 15a. Accordingly, according to the embodiment, it is possible to reduce the power consumed compared to a case where the electrodes are normally scanned using the first driving mode. In addition, since it is possible to reduce the number of electrodes which are scanned, it is possible to easily increase the scanning speed. Due to this, it is possible to perform coordinates detection with high accuracy.

### Applied Examples

Next, examples of combinations of the driving method and the operation screen of the sensor section will be described.

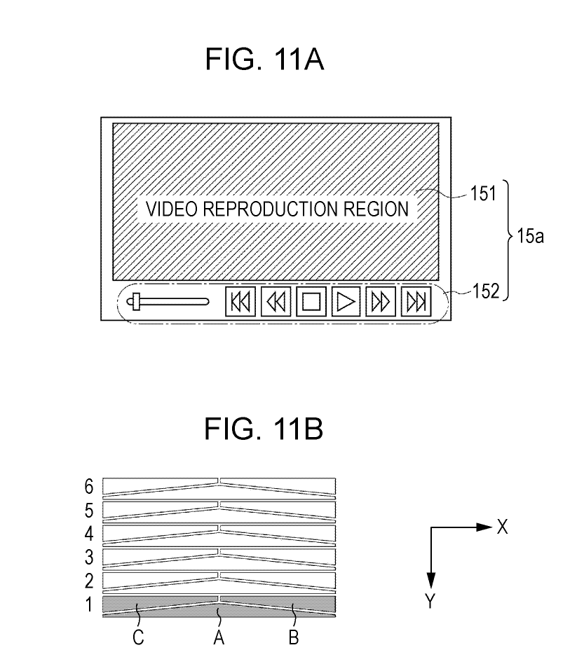

FIG. 11A shows an example of a display on the operation screen where a moving image or a still image is reproduced on the display region 15a. The operation screen has a video reproduction region 151 and an operation region 152. In the video reproduction region 151, a moving image or a still image is reproduced and displayed, and in the operation region 152, operation keys are displayed such as play, stop, pause, fast forward, rewind, volume adjustment, and the like. In the example in FIG. 11A, the operation region 152 is set at the lowest portion on the operation screen. In this case, in the electrode configuration of the sensor section shown in FIG. 11B, using only selective driving of the electrode grouping in the lowest row, touch input to each of the various types of operation keys by the user is detected.

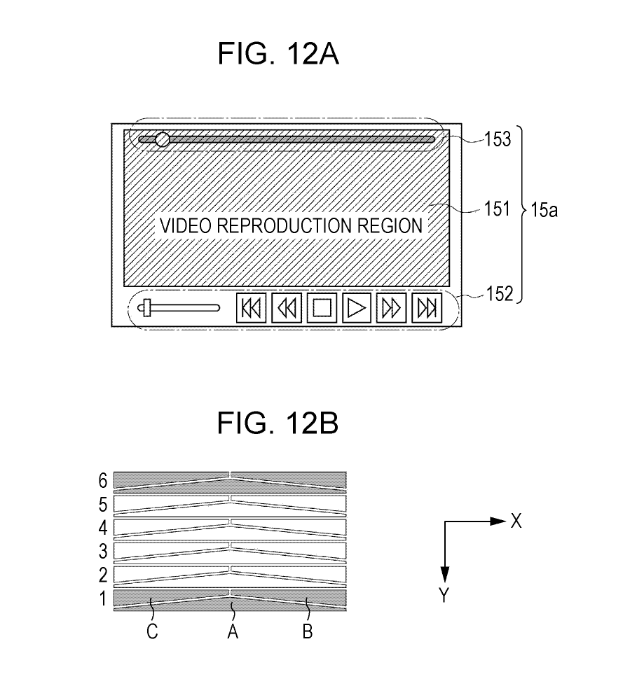

On the other hand, as shown in FIG. 12A, in a case where a second pressing region 153 such as a chapter movement key is displayed at the same time in the highest portion of the operation screen, using only selective driving of the electrode groupings in the highest row and the lowest row in the sensor section as shown in FIG. 12B, touch input to each of the operation regions is detected.

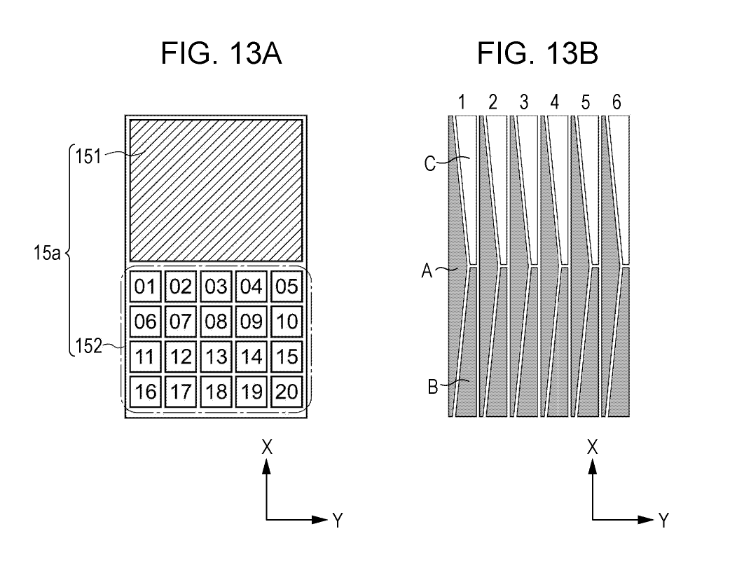

In FIG. 13A, the operation screen has the video reproduction region 151 in the upper half of the screen and has the operation region 152, where various types of operation keys such as numerical keys, in the lower half of the screen. In this case, the sensor section only selective drives each row of the electrodes A and the electrodes B as shown in FIG. 13B.

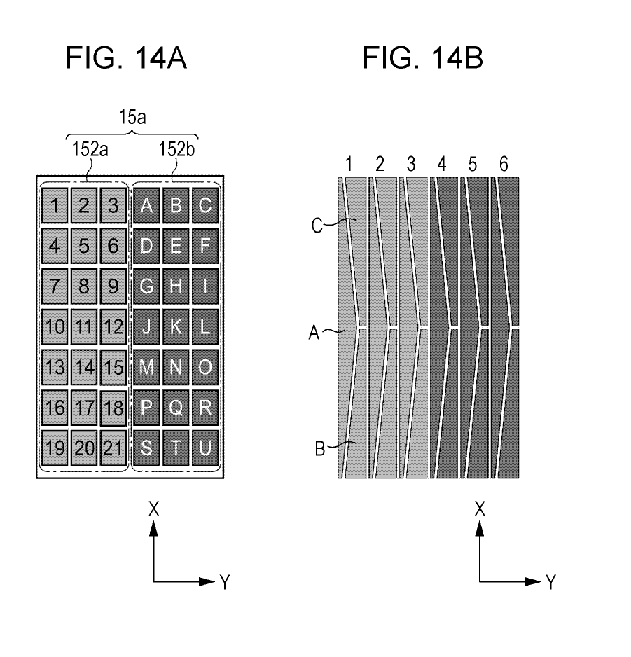

In the operation screen shown in FIG. 14A, a first operation region 152a is arranged in the left half of the screen and a second operation region 152b is arranged in the right half of the screen. In the example shown in the diagram, numerical keys are arranged in the first operation region 152a and alphabetical keys are arranged in the second operation region 152b. In this case, as shown in FIG. 14B, in the sensor section, the first to the third row of the electrode groupings and the forth to the sixth row of the electrode groupings are selective driven independently of each other. In particular, this example is effective in cases such as where the operation keys of each region are operated at the same time.

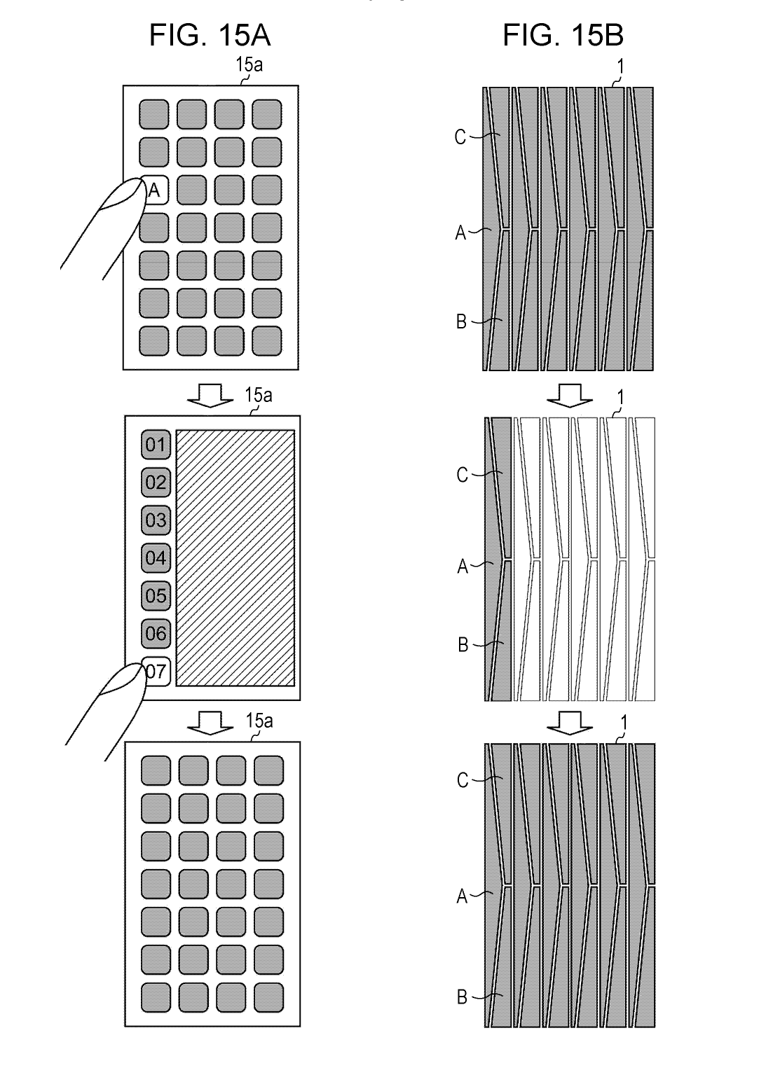

FIGS. 15A and 15B show a modified example of the driving mode of the sensor section in accordance with the switching of the operation screen, where FIG. 15A shows an example of a display on the operation screen and FIG. 15B shows a driving mode of the sensor section 1 in accordance with the operation screen.

In the operation screen shown in the upper level in FIGS. 15A and 15B, initially, a plurality of operation keys which span substantially the entire region of the display region 15a are arranged in a matrix format and the entire operation screen is the operation region. In this state, the sensor section 1 is set in the first driving mode (standard driving mode). Then, when a touch input of a predetermined operation key in the operation region is detected, the operation screen of the input device switches as shown in the middle level of the diagram and the driving mode of the sensor section changes according to this. The operation screen in the middle level of the diagram has an operation region on the left edge of the screen and has, for example, a video reproduction region in the other region. At this time, the sensor section 1 is able to detect a touch operation to the operation region using only selective driving of the electrode groupings on the far left row. Next, when a predetermined operation key (for example, the operation key at the bottom edge) is operated, the operation screen returns to the initial state as shown in the lower level of the diagram, and in the same manner, the driving method of the sensor section is changed to the standard driving mode.

The input device 100 of the embodiment is able to detect not only the position coordinates of the finger tip on the input operation surface 15 but also the movement direction, amount of movement, and the like of the finger tip on the input operation surface 15. Below, image display control examples using the movement of a finger tip will be described.

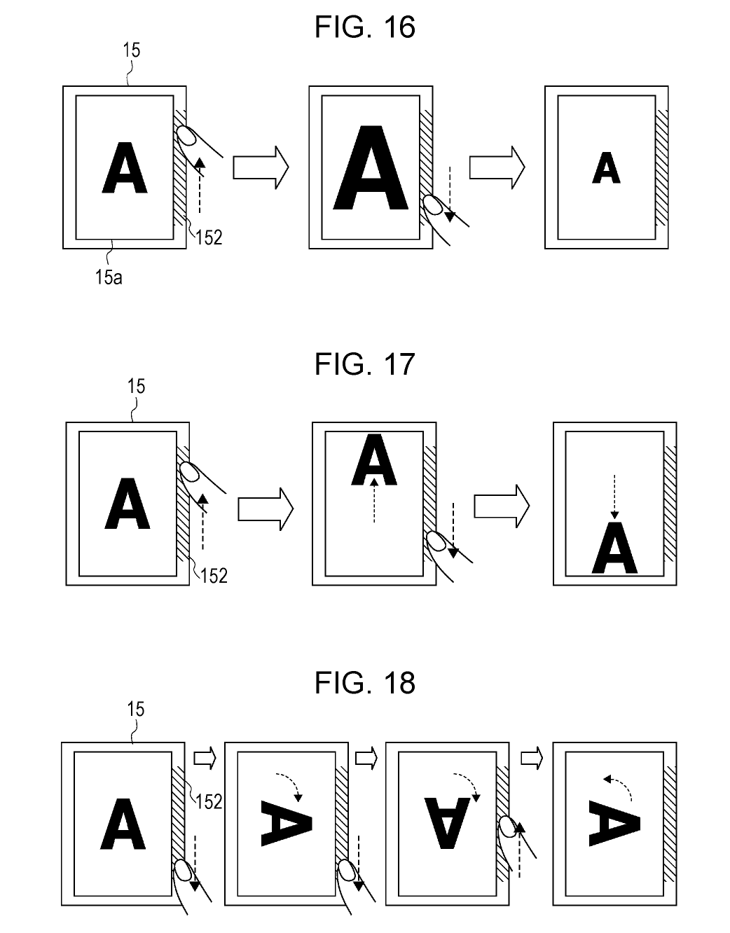

FIGS. 16 to 21 show image operation control examples using the movement of a finger tip. The operation region 152 is set along an edge portion on one side (the left side) of the input operation surface 15 and only the electrodes which belong to the operation region 152 are selectively driven. The operation region 152 is arranged on an outer side of the display region 15a as shown in the diagram but the arrangement is not limited to this.

FIG. 16 shows one example of an operation screen where image enlargement and reduction is possible. In this example, by upward movement of a finger tip directly above the operation screen 152, an image is enlarged in accordance to the amount of movement and displayed, and in reverse, by downward movement of a finger tip, an image is reduced in accordance to the amount of movement and displayed.

FIG. 17 shows one example of an operation screen where image movement control is possible. In this example, by upward movement of a finger tip directly above the operation screen 152, an image is moved upward in accordance to the amount of movement and displayed, and in reverse, by downward movement of a finger tip, an image is moved downward in accordance to the amount of movement and displayed.

FIG. 18 shows one example of an operation screen where image rotation control is possible. In this example, by upward movement of a finger tip directly above the operation screen 152, an image is rotated clockwise in accordance to the amount of movement and displayed, and in reverse, by downward movement of a finger tip, an image is rotated anticlockwise in accordance to the amount of movement and displayed.

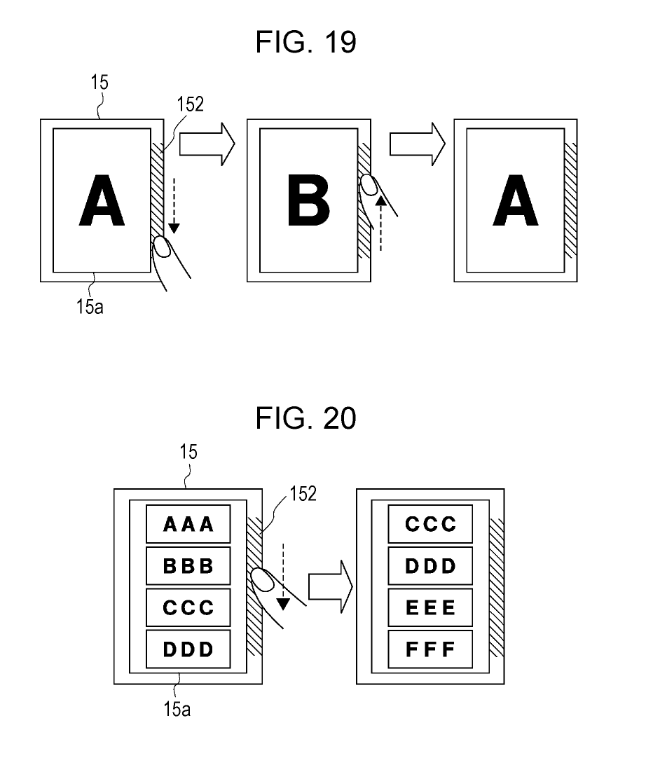

FIG. 19 shows one example of an operation screen where image display changes are possible. In this example, by downward movement of a finger tip directly above the operation screen 152, an image is changed in a predetermined sequence in accordance to the amount of movement and displayed. As the predetermined sequence, for example, in a case where the display images are alphabetical letters as shown in the diagram, the display is changed in order of the alphabet, and in a case of the syllabic Japanese script, the display is changed in order of the fifty sounds. On the other hand, in reverse, in a case where a finger tip is moved upward, the display is changed using a sequence which is the reverse of the predetermined sequence.

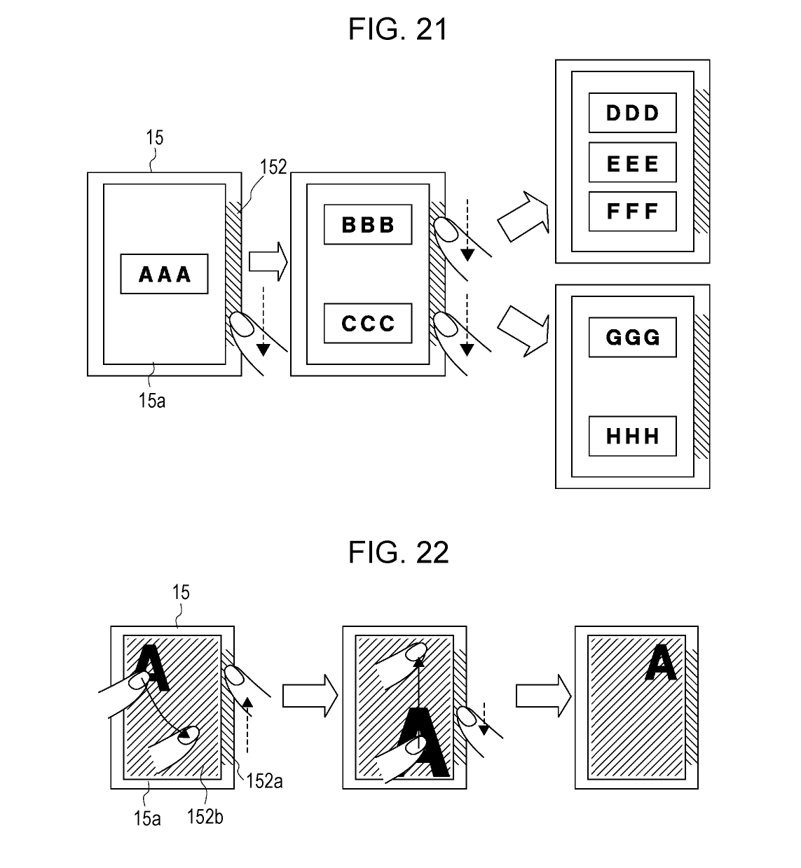

FIGS. 20 and 21 show examples of operation screens where image scroll control is possible. In the same manner as these examples, an image is moved in an up or down direction in accordance with the movement directions of a finger tip F and displayed. For example, it is used in the display of an address book, a title list of files, or the like. FIG. 21 shows an example where it is possible to display the displayed files in a hierarchical manner, and by up or down movement on the operation screen 152 in the vicinity of a file image which is the target, the file list which includes the file may be sequentially displayed.

FIGS. 22 to 24 show examples of operation screens where a plurality of operation regions are set.

In the operation screen shown in FIG. 22, the first operation region 152a is set along an edge portion on the right side of the input operation surface 15 and the second operation region 152b is set in the display region 15a. The first operation region 152a is used in the enlargement or reduction of the image display. The second operation region 152b is used in the image movement display. Due to this, it is possible to realize an image enlargement or reduction operation and an image movement operation together in the same screen.

As the driving method of the sensor section in this case, the partitioned driving mode (the first partitioned driving mode) of the full scan mode (the first driving mode) may be used or the standard driving mode (the second standard driving mode) or the partitioned driving mode (the second partitioned driving mode) of the partial scan mode (the second driving mode) may be used.

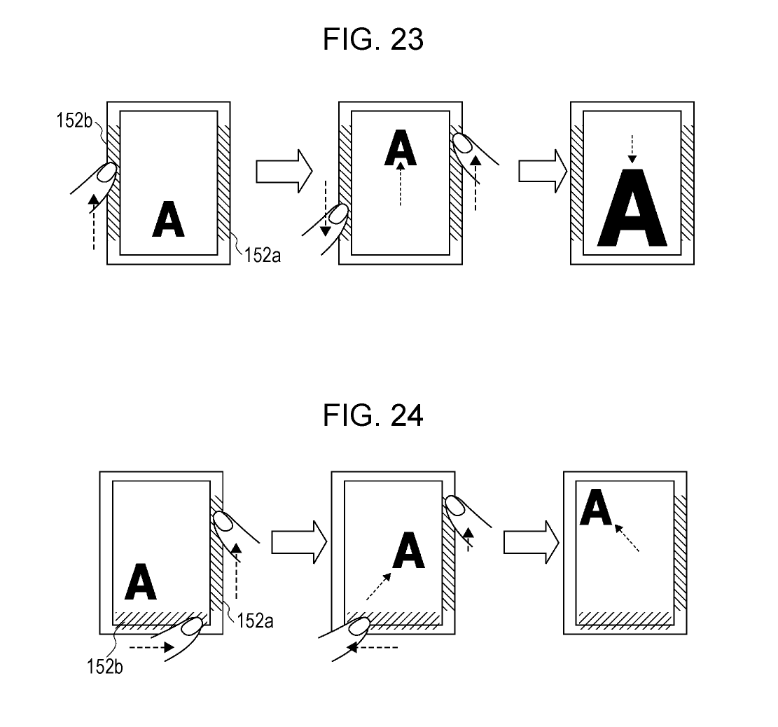

In the operation screen shown in FIG. 23, the first operation region 152a is set along an edge portion on the right side of the input operation surface 15 and the second operation region 152b is set along an edge portion on the left side of the input operation surface 15. The first operation region 152a is used in the enlargement or reduction of the image display. The second operation region 152b is used in the image movement display. The driving method of the sensor section in this case may be the second standard driving mode or may be the second partitioned driving mode.

In the operation screen shown in FIG. 24, the first operation region 152a is set along an edge portion on the right side of the input operation surface 15 and the second operation region 152b is set along an edge portion on the lower side of the input operation surface 15. In this example where both the first and the second operation regions 152a and 152b are used in the image movement display, the first operation region 152a is equivalent to the Y axial coordinate and the second operation region 152b is equivalent to the X axial coordinate, and the XY coordinates of the image are determined using a composite vector of the operations in each of the operation regions. As the driving method of the sensor section in this case, the second partitioned driving mode is selected. Due to this, it is possible to detect the input position in each of the operation regions at the same time.

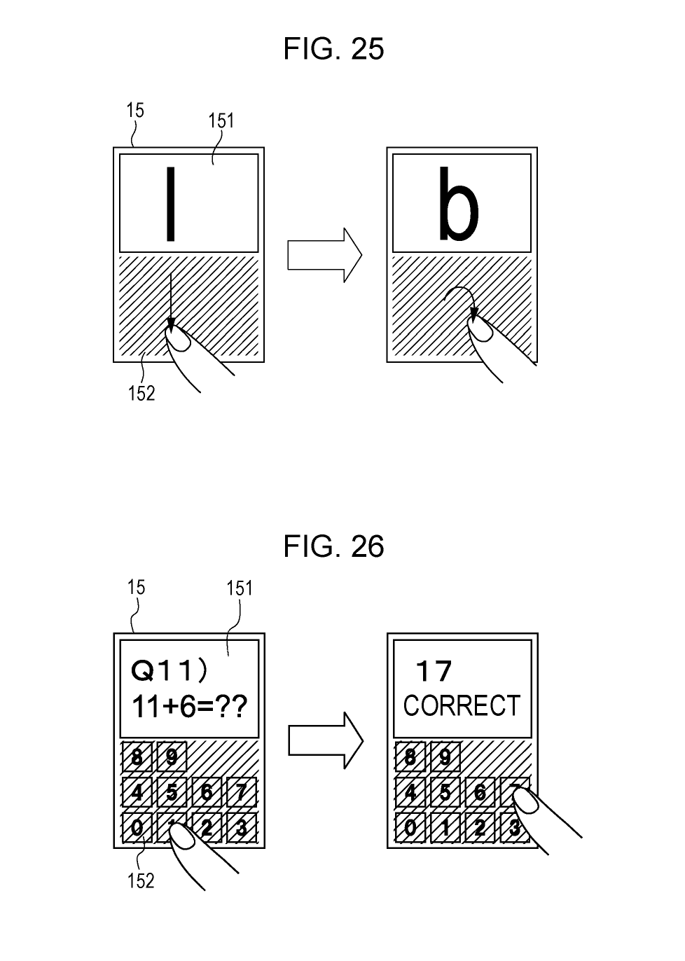

FIG. 25 shows an example of an operation screen which is used in inputting handwriting in the operation region. The operation region 152, where inputting handwriting is possible, is arranged in a region in the lower half of the input operation surface 15, and a display region 151, where the input handwritten image is displayed, is arranged in the upper half of the input operation surface 15. According to the input device of the embodiment, it is possible to detect the trajectory of the movement of a finger tip with high accuracy by selective driving of the electrodes which belong to the operation region 152 using the second standard driving mode.

FIG. 26 shows an example of an operation screen where an application such as a quiz game is applied. The display region 151, which displays content of the questions and whether the answers are correct, is arranged in a region in the upper half of the input operation surface 15, and the operation region 152, where the operation keys are arranged for answering problems which are set, is arranged in the lower half of the input operation surface 15. Also, in this case, the sensor section is selective driven using the second standard driving mode.

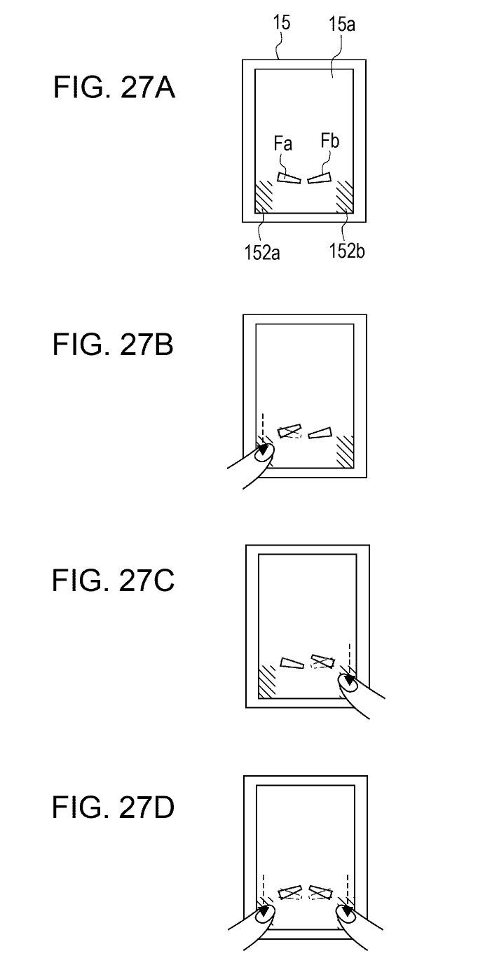

FIGS. 27A to 27D show an example of an operation screen where game software such as pinball is applied. The first operation region 152a is arranged in a region in the lower left corner of the display region 15a and a flipper Fa on the left side is driven by a touch operation by the user being detected. In addition, the second operation region 152b is arranged in a region in the lower right corner of the display region 15a and a flipper Fb on the right side is driven by a touch operation by the user being detected. Using the second partitioned driving mode, it is possible to operate the operation targets at the same time by mutually independently detecting the touch operations to the first and second operation regions 152a and 152b.

Above, the embodiment of the disclosure has been described, but the disclosure is not limited to this and various modifications are possible based on the technical concept of the disclosure.

For example, in the embodiment above, the example of the electrode configuration shown in FIG. 2 has been described as the sensor section 1, but the electrode configuration of the sensor section is not limited to this, and examples shown in FIGS. 28 to 30 are able to be applied.

The electrode configuration shown in FIG. 28 has an electrode configuration of a so-called cross matrix format, which has a X coordinate detection electrode 21x and a Y coordinate detection electrode 21y, and the XY coordinates of the input position are detected based on a change in the cross capacitance between both of the electrodes 21x and 21y. In this example, signal pulses for driving are sequentially input into each row of the detection electrodes 21 and the change in capacitance of another detection electrode 21y which is orthogonal with the detection electrode 21x which inputting was performed. Accordingly, by limited the detection electrodes 21x where the signal pulse is input, it is possible to realize a driving method which is equivalent to the partial driving mode described above.

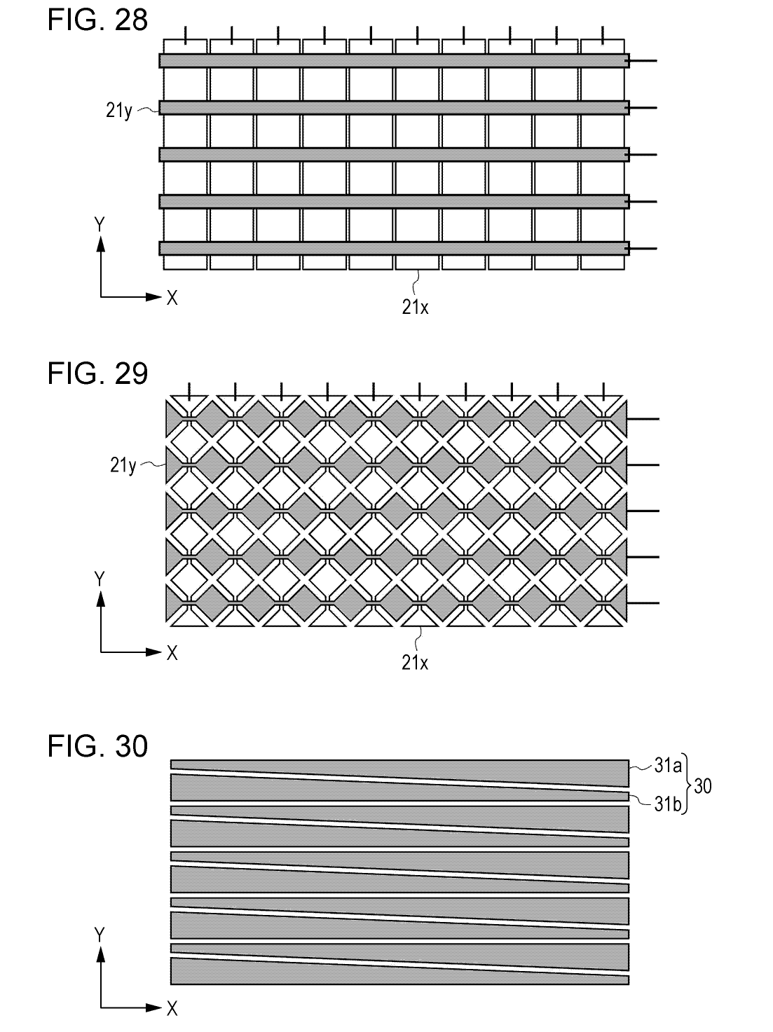

FIG. 29 shows an electrode configuration where the non-intersecting regions of each of the detection electrodes 21x and 21y have a diamond shape in an electrode configuration with a cross matrix format. In this example, changes in the capacitance of each of the detection electrodes 21x and 21y is detected using a so-called self capacitance method, but a method, where changes in the cross capacitance of each of the electrodes is detected as above, may be adopted. Also in this example, by limited the detection electrodes 21x where the signal pulse is input, it is possible to realize a driving method which is equivalent to the partial driving mode described above.

FIG. 30 has an electrode configuration where a plurality of electrode groupings 30 which extend in the X axial direction are arranged in the Y axial direction. Each of the electrode groupings 30 has two triangular detection electrodes 31a and 31b where a rectangle is partitioned along a diagonal line and is arranged in the X axial direction so as sloping sides of each of the detection electrodes face each other with a small gap in-between. According to the electrode configuration such as this, since the area of a finger which overlaps with each of the detection electrodes 31a and 31b changes in accordance with the position of the finger along the X axial direction, the touch position of the finger is specified based on the rate of change in the capacitance between the detection electrodes 31a and 31b or between the electrode groupings 30. In this example, by limited the number of the detection electrodes 31a and 31b or the number of the electrode groupings 30 which are driven, it is possible to realize a driving method which is equivalent to the partial driving mode described above.

The present disclosure contains subject matter related to that disclosed in Japanese Priority Patent Application JP 2010-249975 filed in the Japan Patent Office on Nov. 8, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. An input device comprising:
an input operation surface which includes a display region;
a display element configured to display an operation screen, where an operation region is included in at least a portion thereof, in the display region;
a sensor section comprising a plurality of electrodes that are individually driven using scanning of electric signals and configured to electrostatically detect an input position in the input operation surface; and
a driving section that has a first driving mode where all out of the plurality of electrodes are driven and a second driving mode where a portion of the electrodes out of the plurality of electrodes are driven and which is configured to calculate coordinates of the input position by executing either the first driving mode or the second driving mode in accordance with the operation region.

2. The input device according to claim 1,
wherein the first driving mode has a first standard driving mode to calculate the coordinates of the input position by sequentially driving all of the plurality of electrodes and a first partitioned driving mode which partitions the plurality of electrodes in the operation region into a plurality of regions, and by driving the electrodes in each of the partitioned regions, calculates the respective coordinates of the input position in each of the regions, and
when the first driving mode is selected, the driving section further selects either the first standard driving mode or the first partitioned driving mode.

3. The input device according to claim 1,
wherein the second driving mode has a second standard driving mode to calculate the coordinates of the input position by sequentially driving a portion of the electrodes out of the plurality of electrodes and a second partitioned driving mode which partitions the portion of the electrodes in the operation region into a plurality of regions, and by driving the electrodes in each of the partitioned regions, calculates the respective coordinates of the input position in each of the regions, and
when the second driving mode is selected, the driving section further selects either the second standard driving mode or the second partitioned driving mode.

4. The input device according to claim 1, further comprising:
a display control section configured to output a screen control signal that controls display of the operation screen to the display element and to output a region signal in relation to the operation region in the operation screen to the driving section,
wherein the driving section is configured to select either the first driving mode or the second driving mode based at least in part on the region signal.

5. The input device according to claim 1,
wherein the sensor section further comprises a support body which is arranged between the input operation surface and the display element and supports the plurality of electrodes together, and
the plurality of electrodes are arranged on the support body along a first direction and a second direction, which is orthogonal to the first direction.

6. The input device according to claim 5,
wherein the sensor section comprises a first electrode which has a first region, where a height dimension which is parallel to the second direction becomes gradually larger in relation to a width direction which is parallel to the first direction, and a second region, where the height dimension becomes gradually smaller in relation to the width direction, a second electrode which is formed so as to face the first region in the second direction and so that the height dimension which is parallel to the second direction becomes gradually smaller in relation to the first direction, and a third electrode which is formed so as to face the second region in the second direction, to face the second electrode in the first direction, and so that the height dimension which is parallel to the second direction becomes gradually larger in relation to the first direction, and
a plurality of the groupings of the first electrode, the second electrode, and the third electrode are arranged along the second direction on the support body.

7. A coordinate detection method comprising:
displaying an operation screen, where an operation region is included in at least a portion thereof, in a display region of an input operation surface;
selecting a plurality of electrodes, which are individually driven using an operation of electric signals, from among a plurality of electrodes, which electrostatically detect an input position in the input operation surface, in accordance with the operation region; and
calculating coordinates of the input position by driving the selected plurality of electrodes.

8. A program which makes an input device execute a process comprising:
displaying an operation screen, where an operation region is included in at least a portion thereof, in a display region of an input operation surface;
selecting a plurality of electrodes, which are individually driven using an operation of electric signals, from among a plurality of electrodes, which electrostatically detect an input position in the input operation surface, in accordance with the operation region; and
calculating coordinates of the input position by driving the selected plurality of electrodes.
